(19) United States
(12) Patent Application Publication
(10) Pub. No.: US 2012/0041810 A1
(43) Pub. Date: Feb. 16, 2012

(54) Universal System and Method for Loyalty Currency Redemption

(75) Inventor: Dominic Hofer, Zurich (CH)

(73) Assignee: Loylogic Licensing Inc., Kuesnacht (CH)

(21) Appl. No.: 12/855,898

(22) Filed: Aug. 13, 2010

(51) Int. Cl. G06Q 30/00

(52) U.S. Cl. 705/14.23

(57) ABSTRACT

Systems and methods are disclosed for generating payment values of goods and services (rewards). The disclosed systems and methods can include dynamically calculating, based upon a received input, a plurality of payment pairs, each of the plurality of payment pairs comprising a non-monetary currency value and/or a monetary currency value. The monetary currency value is paid to a universal currency server provider. The non-monetary currency value is redeemed from a reward program and a credit based on the redeemed non-monetary currency value is paid to the provider of the universal currency server. The provider of the universal currency server can deduct a fee for its services from the combination of the monetary currency value and the non-monetary currency value and send a credit for the remaining value to the merchant providing the goods or services.

### RELATED APPLICATIONS

The present application incorporates herein by reference the entire content of the following related applications: U.S. patent application Ser. No. 12/729,746, filed Mar. 23, 2010, and entitled “Methods and Systems for Generating Dynamic Reward Currency Values” and U.S. patent application Ser. No. ______, filed Aug. 13, 2010, having attorney docket number 18113.105004, and entitled “A Mobile System and Method for Loyalty Currency Redemption”.

### BACKGROUND OF THE INVENTION

I. Field of the Invention

The present invention generally relates to the fields of computer systems and communications. More particularly, a system and method are provided to facilitate redemption and use of loyalty/reward currencies for purchases from merchants that are not affiliated with a specified reward currency. More particularly, the system and method relates to a web based platform for utilizing non-monetary reward currency in on-line purchases wherein the system facilitates the use of non-monetary reward currency for on-line purchases of items from retailer systems that do not recognize the non-monetary currency as a vehicle for use in purchasing items. The system and method facilitates redemption and use of a myriad of loyalty/reward currencies from a plurality of different loyalty/reward programs to purchase items from any one of a plurality of retailers, wherein the retailer systems need not be configured to accept the non-monetary reward currency.

II. Background Information

To attract, retain and direct customers, employees and partners, an enterprise may provide a loyalty, motivation or similar reward program. In driving certain behavior, the program sponsoring enterprise distributes a non-monetary currency (e.g., points, miles or other) as an incentive to the program participants for achieving certain predefined objectives. The non-monetary currency distributed to the program participants as a reward can be redeemed by the program participants to purchase specific goods and services designated by the program sponsoring enterprise. For example, an airline's frequent flyer program provides non-monetary currency in the form of frequent flyer miles to customers participating in the frequent flyer program. The customer may redeem any accrued frequent flyer miles for free flights, upgrades or other rewards designated by the program sponsor. In some situations, customers may not have enough miles to redeem for a desired reward. For example, a customer may have enough accrued miles to redeem toward the purchase of a good or service, but the customer may not currently have accrued enough miles for the reward they desire the most. The conventional strategy is to statically limit the goods and services reward choices of a customer to the goods and services that their current mileage account balance may afford. This often causes problems because the conventional strategy does not permit a customer to self-determine how to use a reward.

In view of the foregoing, there is a need for methods and systems that allow a customer to use reward currencies not only for the products and services defined by the loyalty provider's reward program, but a system that facilitates the use of program reward currencies in the purchase of products that are not directly designated by the program sponsor. Furthermore, there is a need for a system and method that allows merchants to sell products and services which can be paid for in whole or in part with non-monetary currency that is converted to monetary currency by a currency conversion service provider.

There is a need for methods and systems allowing the customer to use the loyalty currency to purchase items that may have a high value to the reward participant but a stabilized loyalty currency cost to the reward program sponsor that issues a respective reward currency. For example, as a reward program participant, a customer may not have a need for a flight or a box of chocolates that may be offered by the program sponsor. However, the customer may have a need for clothing, shoes or jewelry, which may be valued at a cost to the program sponsor of $50, but the value to the customer is significantly higher because the item may be one the customer desires or needs. There is a further need for a system that presents a customer that has accumulated reward currency with an option to select and purchase items that are not designated for purchase by a reward program sponsor, wherein the items selected may be purchased directly from retailers.

### SUMMARY OF THE INVENTION

Consistent with embodiments of the present invention, systems and methods are disclosed that enable redemption of loyalty/reward currencies through a universal currency system. The system and method generally comprises a web based platform for utilizing non-monetary reward currency in on-line retail purchases wherein the system facilitates the use of non-monetary reward currency for on-line purchases of items from retailer systems that do not recognize the non-monetary currency as a vehicle for use in purchasing retail items. The system and method facilitates redemption and use of a myriad of loyalty/reward currencies from a plurality of different loyalty/reward programs to purchase items from any one or a combination of a plurality of retailers, wherein the retailer systems need not be configured to accept the non-monetary reward currency.

In accordance with one embodiment, a system and a computer implemented method of facilitating a web based retail purchase utilizing a universal currency system is implemented by performing a series of steps. First, through use of a computing device, a user selects an item for purchase at the website of a retailer. The retailer website, configured to communicate with the universal currency system, presents on the user's computing device, an option to use non-monetary currency in purchasing the item selected. Upon the user making an interactive selection to use the universal currency system, the user is directed to a universal currency module within the universal currency system which facilitates user log-in to a universal currency account following entry by the user of log-in data into login data fields presented by the universal currency module, wherein the universal currency account is associated with at least one loyalty program account of the user and includes at least data representative of accumulated non-monetary currency of the at least one loyalty program. Following a selection of a loyalty program, and thereby the loyalty program account of the user associated therewith, the universal currency module enables the purchase of the item selected using at least a portion of the non-monetary currency accumulated by the user in the loyalty program account of the user of the loyalty program selected. Another embodiment comprises a computer-readable medium which stores a set of instructions which when executed perform the steps of the computer implemented method.

According to another embodiment, a system and method facilitates the purchase of the item selected using a payment pair comprising a non-monetary currency component and a monetary currency component, wherein the universal currency system determines the currency component amounts of the payment pair used in the purchase of the item selected. Another embodiment comprises a computer-readable medium which stores a set of instructions which when executed perform the steps of the computer implemented method.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description and include systems and methods for determining the required monetary currency value, given a non-monetary currency payment value to determine the overall price of a good or service for a currency/non-currency payment combination.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram depicting a system for implementing the method of redeeming loyalty/reward currency for retail purchases at retailer web sites that may not be affiliated with a specified reward currency, consistent with an embodiment of the present invention.

FIG. 2 is a block diagram of the exemplary system for redeeming loyalty/reward currency for retail purchases at retailer web sites of FIG. 1 shown in more detail consistent with an embodiment of the present invention.

FIG. 3 is a block diagram of the exemplary system for redeeming loyalty/reward currency for retail purchases at retailer web sites of FIG. 2 shown in more detail consistent with an embodiment of the present invention.

FIG. 4A and FIG. 4B contain a flow chart of an exemplary method of redeeming loyalty/reward currency for retail purchases at retailer web sites that may not be affiliated with a specified reward currency, consistent with an embodiment of the present invention.

FIG. 5 is an illustration of a retailer website illustrating links directing the user from the retailer website to a plurality of payment systems, including the universal currency system of the present invention.

FIG. 6 is an illustration of an embodiment of the graphical user interface for the system login of the present invention.

FIG. 7 is an illustration of an embodiment of the present invention illustrating a graphical user interface for the system at which a user selects a preferred loyalty program account, from a plurality of user loyalty program accounts, from which to redeem non-monetary currency to purchase a retail item.

FIG. 8 is an illustration of an embodiment of the slider module of the present invention.

FIG. 9 is an illustration of an embodiment of a confirmation screen following successful purchase of an item from a retailer website.

FIG. 10 is another illustration of an embodiment of the present invention illustrating a graphical user interface for the system at which a user selects a preferred loyalty program account, from a plurality of user loyalty program accounts, from which to redeem non-monetary currency to purchase a retail item.

FIG. 11 is an illustration of an embodiment of the present invention of a graphical user interface for user login into a loyalty program account within the user account following selection of the loyalty program account from a plurality of accounts;

FIG. 12 is an illustration of an embodiment of the slider module of the present invention.

FIG. 13 is an illustration of an embodiment of a confirmation screen following successful purchase of an item from a retailer website.

FIG. 14 is an exemplary non-monetary reward currency value requirements curve showing the dynamic value of non-monetary reward currency that depends on the amount of cash added to the non-monetary reward currency in total payment for a reward consistent with an embodiment of the present invention.

FIG. 15 is an exemplary non-monetary reward currency requirements curve showing the plurality of possible payment pairs comprised of a non-monetary currency component and a monetary currency component along a continuum of possible combinations, consistent with an embodiment of the present invention.

FIG. 16 is a flow chart of an exemplary method of redeeming loyalty currency for monetary currency in accordance with an embodiment of the invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

Systems and methods consistent with embodiments of the present invention may be used to facilitate the use of a non-monetary reward in on-line retail purchases. A universal non-monetary currency system is engaged to facilitate the use of non-monetary reward currency, accumulated in a reward program, for on-line purchases of items from retailer web-based retail platforms that do not recognize the non-monetary currency as currency for use in purchasing retail items. The universal non-monetary currency system is integrated into the payment process of a retailer's website. A user accessing a retailer's web-site can access the universal non-monetary currency system in order to facilitate payment for an item being purchased at a retailer web-site using a non-monetary reward currency, even though the retailer does not recognize or accept the non-monetary reward currency. The terms “retailer website” and “retailer server” are used broadly herein to refer to any merchant selling goods or services in an on-line computing environment.

In a reward program, a user may earn or otherwise receive non-monetary currency that may be used to redeem a reward. The non-monetary currency may comprise, but is not limited to, general rewards points, airline frequent flyer miles, or other non-monetary reward currency associated with financial or non-financial accounts. The non-monetary currency may be associated with or otherwise related to a loyalty reward program (for example, a program directed toward consumers), motivation programs (for example, directed towards employees or distributors), or any other program that may leverage a non-monetary currency in order to reward specific behavior. The aforementioned are exemplary and the non-monetary currency may comprise other non-monetary qualities.

Once a non-monetary reward currency is received, the user may wish to redeem an award with the non-monetary currency for products, services, or a combination of products and services selected, for example, by the user. Generally non-monetary currency may be used to purchase products and services offered by the program sponsor, since other retailers and program sponsors receive little if any benefit from allowing a user to redeem another loyalty program sponsors reward to a customer. Allowing a customer to use non-monetary currency to purchase products and services offered by the program sponsor is generally done to generate customer loyalty. In an effort to provide breadth to the products and services for which a non-monetary currency may be used, a program sponsor may purchase items at standard, wholesale or discount prices and offer such products to the consumer. However, in most cases, the list of products for which loyalty currency may be used is limited. Consistent with embodiments of the present invention, the system disclosed herein is used in conjunction with current loyalty program systems to remove limitations on the types of products and venues for which non-monetary currency may be used to purchase goods and services.

Utilizing the system disclosed in the present invention enables a user to use non-monetary currency to purchase goods and services at retailer outlets having no affiliation with the user's loyalty program or any infrastructure capable of accepting the user's non-monetary currency accumulated in a loyalty/reward program. For example, the present invention implements a process by a software module configured with an algorithm that may be used to calculate currency components of a payment pair, comprised of a monetary currency component and a non-monetary currency component, that may be used to purchase goods or services identified by a user. In one embodiment, identifying and inputting either a monetary currency or non-monetary currency amount, results in the generation of a specific payment pair comprised of the currency component input and a corresponding non-monetary component or vice versa.

In another embodiment, the software module may generate a plurality of payment pairs that include calculated currency payment pair values wherein each payment pair comprises, for example, a non-monetary currency component and a monetary currency component. The monetary currency component may comprise a cash amount and may relate to, for example, any known monetary currency. For each payment pair, the combination of the non-monetary and monetary components may correspond to the retail price of the selected good or service or the selected good or service's cost to the reward program member. Furthermore, typically no two non-monetary currency component values within the plurality of payment pairs may be the same. Likewise, typically no two monetary currency component values within the plurality of payment pairs may be the same. Moreover, the value of the non-monetary currency component multiplied by a corresponding currency value plus the monetary currency component value may be equal to the cost value of an item desired to be purchased.

When the user wishes to redeem non-monetary currency to purchase a good or service from a retailer website, the present invention provides the user with an option of using non-monetary currency only, non-monetary currency in combination with monetary currency or monetary currency alone. When the user desires to use a combination of monetary and non-monetary currency, the user may determine the amount of monetary currency that shall be used in combination with non-monetary currency to purchase an item. The user inputs the desired amount of monetary currency into the system via the system's universal currency software module. Upon input of the monetary currency, the universal currency software module presents a payment pair comprised of a non-monetary currency component and the monetary currency component input. The non-monetary currency component is generated by the universal currency software module in direct response to the monetary currency amount input. The payment pair presented to the user may be accepted, rejected or modified. If the payment pair is rejected, the user is provided with an opportunity to modify either of the monetary or non-monetary currency components of the payment pair, which shall generate an alternate payment pair comprising different monetary and non-monetary currency components values.

As an alternative, if the user is not aware of the amount of monetary currency they would like to use and also does not have enough non-monetary currency to purchase a desired item, the user may input an amount less than the required level of non-monetary currency into the system to purchase an item. Upon the input of the non-monetary currency amount, the currency values software module generates a payment pair comprised of the non-monetary currency amount input and a generated monetary currency amount. It is to be understood that the currency values software module is flexible and is not limited to a specific number of payment pairs. Payment pairs are generated based on the input values of the monetary or non-monetary currency amounts. Consequently, the user may choose any point along, for example, a monetary currency and non-monetary currency continuum as a preferred method of paying for the selected good or service.

In one exemplary embodiment, the monetary currency and non-monetary currency continuum is illustrated by way of a slider module represented as a graphical user interface that comprises an interactive slider. The slider begins at a first end of the currency continuum with a payment pair comprising a non-monetary currency component and a monetary currency component equal to at least one of an amount of zero dollars and an amount of close to zero dollars and ends at a second end of the currency continuum with a payment pair comprising a monetary currency component and non-monetary currency component equal to one of an amount close to zero units and an amount of zero units.

The interactive slider facilitates the presentation of a plurality of payment pairs through movement of the slider along the payment pair continuum, wherein a plurality of payment pairs may be presented to the user upon the user moving the slider over a plurality of points along the payment pair continuum. Through use of the interactive slider, a user generates a plurality of unique payment pairs along the payment pair continuum until a preferred payment pair is identified and selected. A payment pair including both a monetary and a non-monetary component has the monetary component associated with a financial account of the user. In one embodiment, the monetary component may be debited by an amount equal to the monetary currency value associated with the user selected payment pair. Likewise, the rewards currency account selected by the user as currency for a respective purchase may be debited by an amount equal to the non-monetary currency value associated with the user generated and/or selected payment pair.

The aforementioned algorithm within the currency values software module may use as few or as many parameters as desired. Moreover, the algorithm may assign more value, for example, to the value of each incremental unit of non-monetary currency (e.g., each point) the greater the monetary currency value within a respective payment pair. For example, a system user desires to redeem non-monetary currency for goods or services. In this example, the item to be purchased has a retail value of $100, and four potential payment pairs are discussed. The first payment pair may have a 20,000 unit non-monetary currency component and a $0 monetary currency component. The second payment pair, for example, may have a 9,000 unit non-monetary currency component and a $50 monetary currency component. The third payment pair, for example, may have a 1,000 unit non-monetary component value and a $90 monetary currency component. The fourth payment pair may, for example, may have a 0 unit non-monetary component value and a $100 monetary currency component value.

In accordance with the above example, each unit of the 20,000 units of non-monetary currency in the first payment pair's non-monetary currency component may be given a $0.0050 value. Because the second and third payment pair's monetary currency component values are greater than the first payment pair's monetary currency component value, each incremental unit in the second and third payment pair's non-monetary currency component may be given values of $0.0055 and $0.0100 respectively. The non-monetary currency component value in both the second and third payment pairs are greater than each incremental unit in the first payment pair's non-monetary currency value.

Accordingly, because the reward program member is provided the freedom to choose their desired payment strategy, and thereby generates a personalized payment pair, they are also offered the fourth payment pair where they could pay in monetary currency only and, for example, accrue non-monetary currency units for each dollar spent instead of redeeming points. It is contemplated that the universal payment system may be configured to generate universal non-monetary currency units for each dollar spent instead when points are not redeemed and purchases are made with cash alone. The universal non-monetary currency units generated may be combined with the specific non-monetary currency units of a loyalty reward program at the time subsequent purchases are made.

Embodiments of the invention may be practiced in concert with existing loyalty and reward program systems wherein each loyalty program account of the user is associated with an account in the universal currency system in order to facilitate flexibility by the user in determining the reward program currency to be used when making a retail purchase from a merchant.

An embodiment consistent with the invention may comprise a system for determining payment values. The system may comprise a memory storage for maintaining a database and a processing unit coupled to the memory storage. The processing unit may be operative to receive an input. Furthermore, the processing unit may be operative to calculate, based upon the received input, a specific payment pair driven by the input component or a plurality of payment pairs, wherein each payment pair comprises a non-monetary currency component and a monetary currency component.

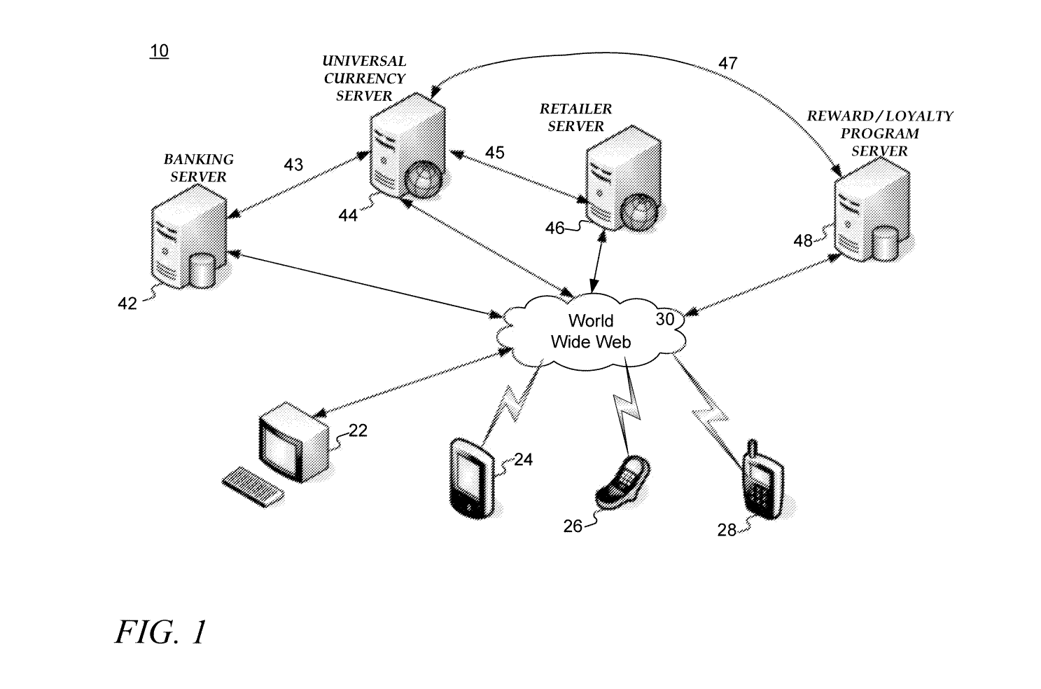

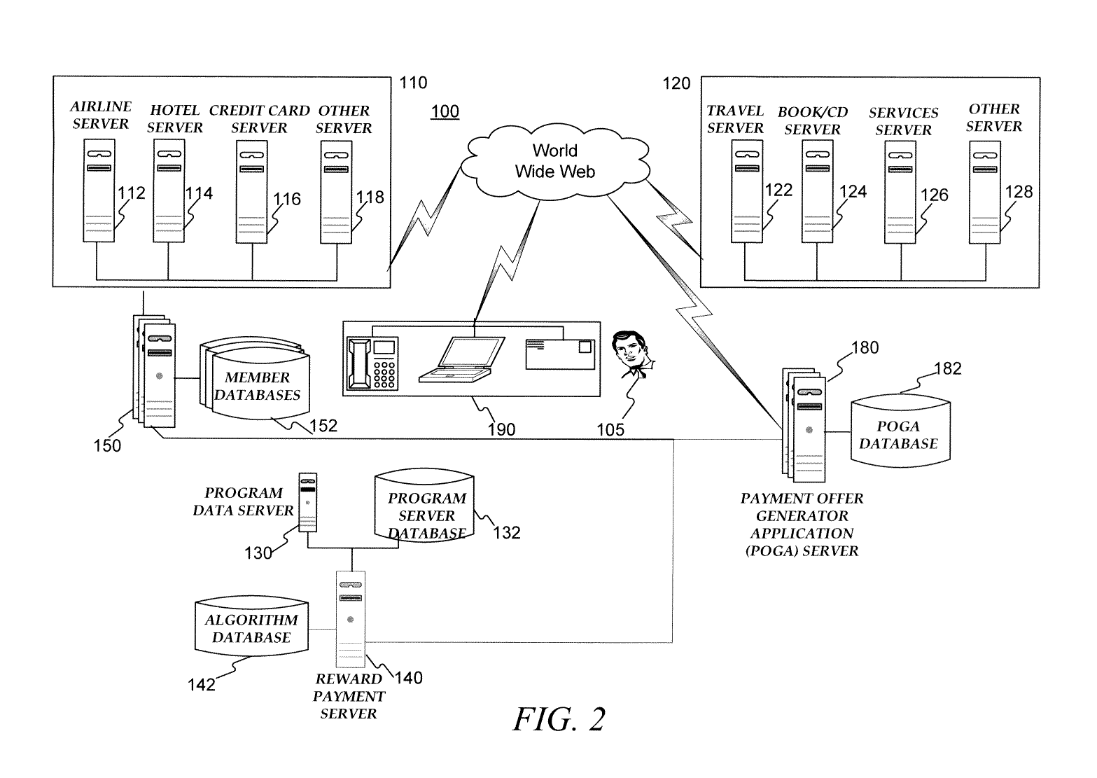

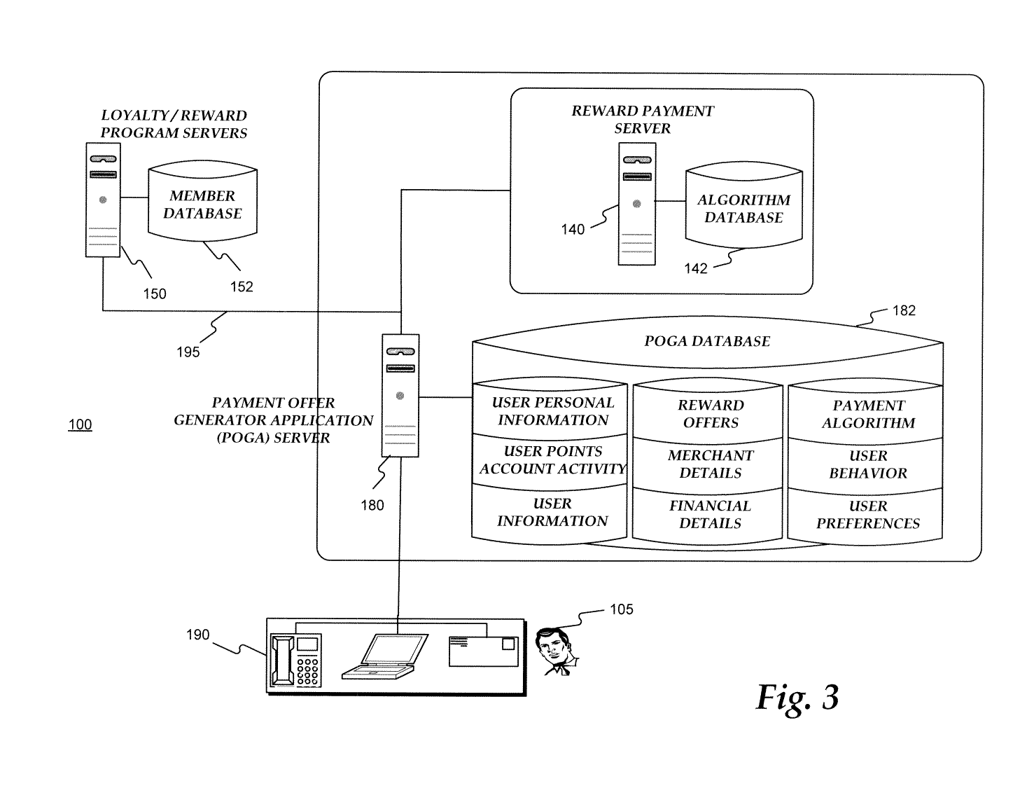

Consistent with an embodiment of the present invention, the aforementioned system including memory, processing unit, and other components, is configured to implement a method facilitating redemption and use of loyalty/reward currencies for retail purchases from retailers that are not affiliated with a specified reward currency. The method utilizes the non-monetary currency within a platform system networked to facilitate on line retail purchases from retailer systems that do not recognize the non-monetary currency as a vehicle for use in purchasing retail items. The system and method facilitates redemption and use of a myriad of loyalty/reward currencies from a plurality of different loyalty/reward programs to purchase items from any one of a plurality of retailers, wherein the retailer systems need not be configured to accept the non-monetary reward currency. Such a system that performs redemption and use of loyalty/reward currencies for retail purchases from retailers that are not affiliated with a specified reward currency dynamic currency payment determining system is illustrated in FIG. 1, FIG. 2 and FIG. 3.

Any suitable combination of hardware, software, and/or firmware may be used to implement the memory, processing unit, or other components. By way of example, the memory, processing unit, or other components may be implemented with any server shown in FIG. 2 and FIG. 3, including, for example, a payment offer generator application (POGA) server 180, in combination with system 100. The aforementioned system and server are exemplary and other systems and servers may comprise the aforementioned memory, processing unit, or other components, consistent with embodiments of the present invention.

By way of a non-limiting example, FIG. 1 illustrates a system 10 in which the features and principles of the present invention may be implemented. As illustrated in FIG. 1, system 10 may include a plurality of user interface devices such as a personal computer, laptop or any other type of personal computing device 22, a PDA 24, a mobile phone 26, or a smart phone 28. Each user interface device may gain access to a retailer web server 46 by way of an Internet or World Wide Web connection 30. Following a selection of the retail item to be purchased, the retail web server 46, which has a link to the universal currency server 44, presents a user accessing the universal server 44 with a plurality of payment options. One of the payment options presented allows a consumer accessing the retail server 46 to make a payment using a universal currency software module operating on the universal currency server 44.

The universal currency server 44, which is operatively connected to retail server 46 is accessed by a consumer following entry of login data, which allows the user to access a universal currency account. Information representative of the item to be purchased is transmitted from the retail server 45 to the universal currency server 44 and utilized by the universal currency software module during payment processing. After accessing the universal currency account within the universal currency server 44, data representative of the reward program accounts associated with the universal currency account are presented to the user's computing device. The information representative of the reward currency accounts may be stored on the universal currency accounts and updated periodically in accordance with timing updates previously defined. Alternatively, the information representative of the reward currency accounts is not stored on the universal currency server, but is stored locally in temporary data storage upon accessing the universal currency account of the user.

Upon accessing a universal currency account, the universal currency server 44 requests information from a plurality of reward program servers 48 that is representative of at least the total amount of non-monetary currency accumulated in each reward program account associated with the universal currency account of the user. Following the user making a selection of the reward program from which the non-monetary currency should be withdrawn to make a purchase, the universal currency software module allows the user to interactively determine a payment pair, comprised of a non-monetary component and a monetary component, that is optimal for the user, whereby the user can increase and decrease each component of the payment pair using a GUI slider until the optimal payment pair is determined.

Upon a determination of the optimal payment pair, a user is allowed to enter an account from which the monetary currency component shall be withdrawn, for example, a checking account, saving account, credit card or any other account based system that facilitates on-line purchase payments. It is contemplated that the user's universal currency account may be associated with a preferred monetary payment method, wherein information representative of a preferred account has been previously stored within the universal currency module and presented to the user for selection by the user. Upon selection of an account from which a monetary component of the payment pair shall be selected, the universal currency server 46 connects to a banking server 42 to facilitate collection of the monetary component of the payment pair. As illustrated in FIG. 1, the retail web server 46 may be connected to the universal currency server 46 by way an Internet connection 30 or a private network connection 45. As FIG. 1 also illustrates, the banking server 42 may be connected to the universal currency server 44 by way an Internet connection 30 or a private network connection 43; and the reward program server 48 may be connected to the universal currency server 46 by way an Internet connection 30 or a private network connection 47.

Referring to the block diagram of FIG. 2 and FIG. 3, the present invention illustrates a system 100 which may include a user 105, marketing partner servers 110, retailer servers 120, a program data server 130, a reward payment server 140, reward program servers 150, a POGA server 180, a user interface 190, and a network 195. FIG. 2 and FIG. 3 illustrate exemplary embodiments of the invention in greater detail than the exemplary overview provided in FIG. 1. In the embodiments in FIG. 2 and FIG. 3, the program data server 130, the reward payment server 140, and the POGA server 180 correspond to the universal currency server 44 illustrated in FIG. 1. In alternate embodiments of the invention, the universal currency server 44 may not necessarily include the program data server 130, the reward payment server 140 and the POGA server 180.

Referring to FIG. 2 and FIG. 3, user 105 may be an individual, for example, desiring to use system 100 to purchase an item at a retailer website located on a retailer server 120. System 100 allows the user 105 to redeem non-monetary currency from a retailer website located on a retailer server 120 by generating a specific payment pair for the item desired to be purchased or by selecting from one of a plurality of payment pairs generated by the POGA server 180, wherein each payment pair generated comprises a non-monetary currency component and monetary currency component. User 105 may also be an organization, enterprise, or any other entity having a desire to purchase an item at a retailer website located on a retailer server 120.

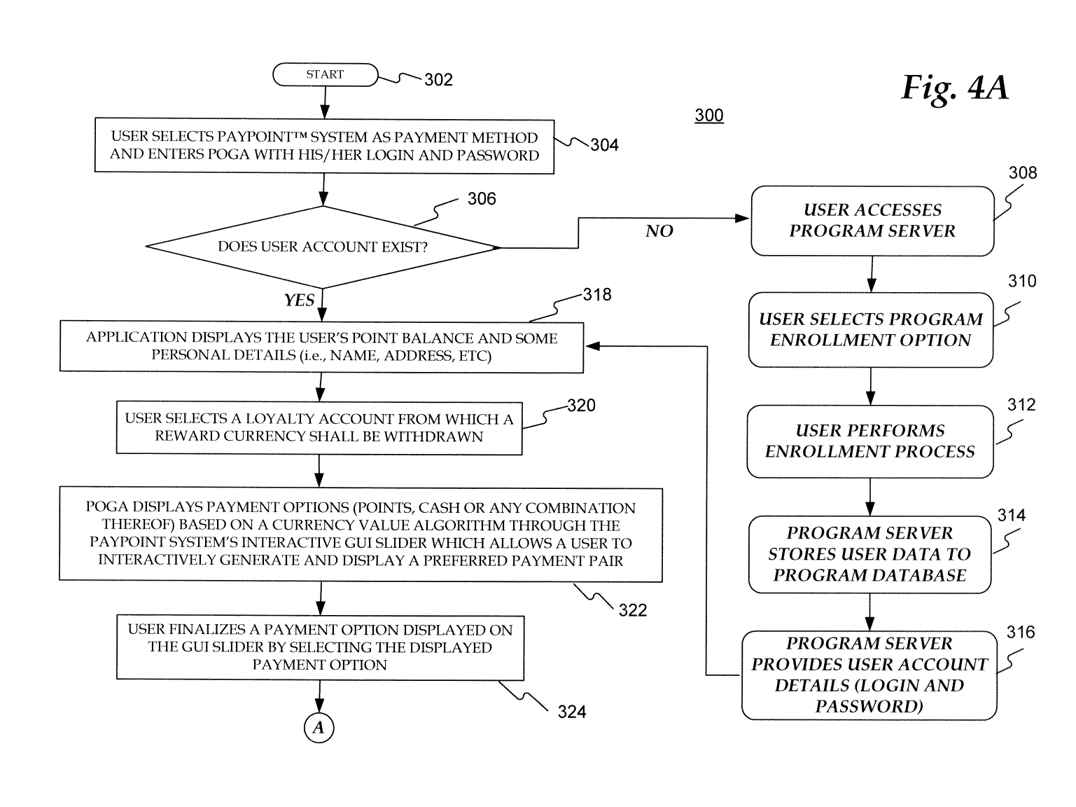

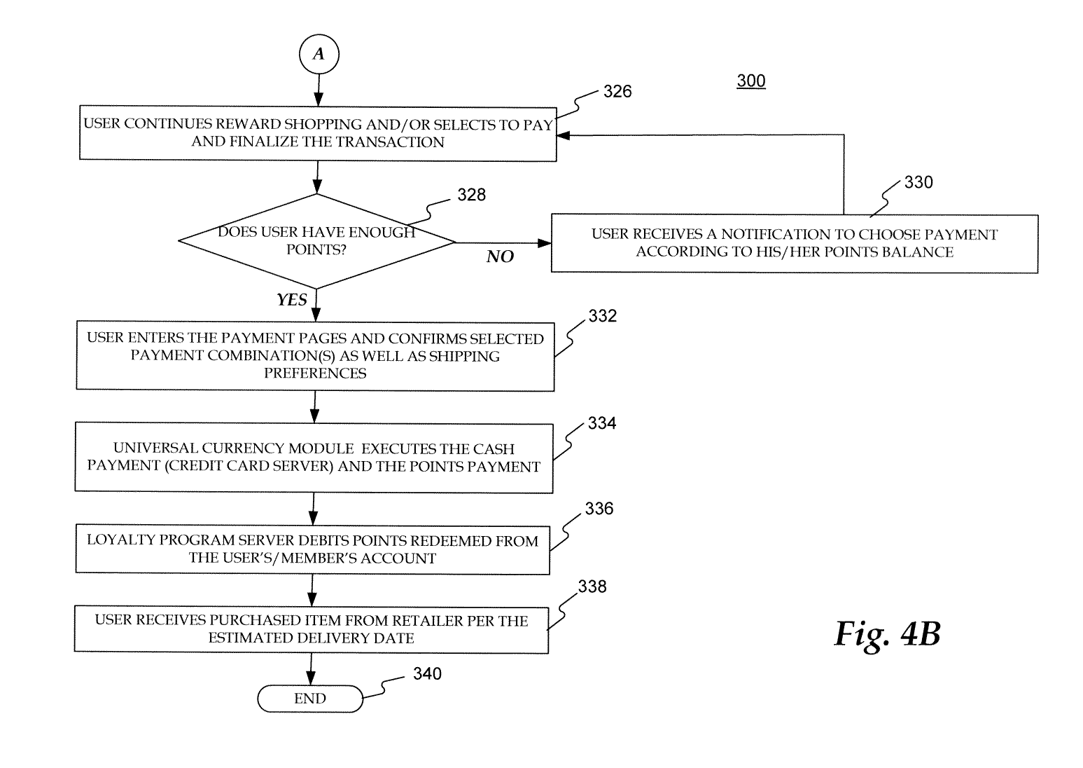

POGA server 180 may include a processing unit and memory. The memory may include a universal currency software module and a currency database. The universal currency software module residing in the memory may be executed on the processing unit, may access the currency database, and may implement processes in conjunction with a payment offer generator application executing a dynamic currency algorithm, an example of which is described below with respect to FIG. 4A and FIG. 4B. Notwithstanding, POGA server 180 may execute other software modules and implement other processes. Furthermore, in another embodiment, a processing unit and memory similar to that described above with respect to POGA server 180 may reside in any server shown in FIG. 2 and FIG. 3 and may implement processes in conjunction with determining payment pair values such as the method described below with respect to FIG. 4A and FIG. 4B.

As shown in FIG. 2, marketing partner servers 110 may comprise, for example, an airline server 112, a hotel server 114, a credit card server 116, and another marketing server 118. Marketing partners of a reward program, operating respective servers, may generate reward currency (e.g., points, miles) to provide customers incentives to be loyal to the products or services offered by the marketing partners. Marketing partners may report non-monetary currency accruals and redemptions, promotions, and other relevant information which is maintained on reward program servers 150. It should also be recognized that other types of servers associated with other types of financial rewards beyond conventional loyalty programs can be associated with marketing partner servers 110. For example, a server associated with a user financial account could be associated with the marketing partner servers 110 and the financial account could be used to issue credits for the payment of goods or services.

Retailer servers 120 may comprise, for example, a travel server 122, a book/CD server 124, a services server 126, and another retailer server 128 at which goods and services are made available for purchase. Retailers operating their respective servers 120, do not need to do anything different in selling their respective products and services to members of the universal reward currency program, since a retailer receives monetary currency only for products and services purchased by users of the present invention.

Program data server 130 may provide reward program financial data such as non-monetary currency conversion cost rates or program rules such as minimum currency redemption per purchase, redemption limits, as well as other program preferences or dedicated requests. Such inputs may be used in the dynamic currency algorithm, an example of which is described in detail below with respect to FIG. 4A and FIG. 4B. Furthermore, program server database 132 may include data from a reward payment provider/licensee such as desired product or service margins or other pertinent information to a given reward program. Reward program servers 150 may access member databases 152 and represent one or multiple (i.e., consolidated into single currency) reward programs (e.g., airline, hotel, car rental, retail, consortium, etc.) offering programs based on their own (not necessarily proprietary) infrastructure and rules (i.e., terms and conditions.)

Reward payment server 140 may consolidate input data that enables a reward payment calculation that may produce a specific payment pair for the item desired to be purchased or a plurality of payment pairs each comprising a non-monetary currency component and a monetary currency component. For example, each payment pair may comprise a cash and/or non-monetary currency component pair of any denomination, based on a flexible non-monetary currency face value that depends on the cash component combined with the non-monetary currency as the means for payment. Algorithms generating reward payment calculations may be different depending upon a reward program and may be tailored to a particular reward program and the reward program sponsor's needs, constraints, and objectives, for example.

POGA server 180 may gather information from various sources and generate the currency components of a payment pair that may be used by a user in purchasing an item. As stated above, the reward offer generated by POGA server 180 may comprise a specific payment pair generated based on the input data. Alternatively, POGA server 180 may present a plurality of payment pairs, each of the plurality of payment pairs comprising, for example, a non-monetary currency component and a monetary currency component. In one embodiment, upon the input of the non-monetary currency amount, the universal currency software module within POGA server 180 generates a payment pair comprised of the non-monetary currency amount input and a generated monetary currency amount.

It is to be understood that the universal currency software module is flexible and is not limited to a specific number of payment pairs. Payment pairs are generated based on the input values of the monetary or non-monetary currency amounts. Consequently, the user may choose any point along, for example, a monetary currency and non-monetary currency continuum as a preferred method of paying for the selected good or service. In the present embodiment, the monetary currency and non-monetary currency continuum is illustrated by way of a slider module which is represented as a graphical user interface that comprises an interactive slider. The slider begins at a first end of the currency continuum with a payment pair comprising a non-monetary currency component and a monetary currency component equal to at least one of an amount of zero dollars and an amount of close to zero dollars and ends at a second end of the currency continuum with a payment pair comprising a monetary currency component and non-monetary currency component equal to one of an amount close to zero units and an amount of zero units.

The interactive slider facilitates the presentation of a plurality of payment pairs through movement of the slider along the payment pair continuum, wherein a plurality of payment pairs may be presented to the user upon the user moving the slider over a plurality of points along the payment pair continuum. Through use of the interactive slider, a user generates a plurality of unique payment pairs along the payment pair continuum until a preferred payment pair is identified and selected. A payment pair including both a monetary and a non-monetary component has the monetary component associated with a financial account of the user. In one embodiment, the monetary component may be debited by an amount equal to the monetary currency value associated with the user selected payment pair. Likewise, the rewards currency account selected by the user as currency for a respective purchase may be debited by an amount equal to the non-monetary currency value associated with the user generated and/or selected payment pair.

Furthermore, the universal currency software module within POGA server 180 may gather information and generate currency payment pairs as described below with respect to FIG. 4A and FIG. 4B. User interface 190 may use web channels (e.g., computer, cable), mobile channels (e.g., mobile phone, PDA), phone channels (e.g., call center, etc.), print channels (e.g., newsletters, catalogues, etc.) or any other interface technology. The aforementioned interfaces are exemplary and others may be used in conjunction with system 100.

FIG. 3 shows system 100 in more detail. As shown in FIG. 3, the universal currency software module running on POGA server 180 may gather the following exemplary type of information from various sources and may generate the reward offer (e.g. including at least one of a plurality of potential payment pairs) for user 105: i) user personal information (e.g., name, address, etc.); ii) user non-monetary currency account activity (e.g., current balance, accumulation rate, etc.); iii) reward program member insights (e.g., elite level, reward preferences, etc.); iv) reward program information (e.g., rules, terms and conditions, etc.); v) merchant product/service offerings (e.g., product/service, item description, item picture, etc.); vi) merchant details (e.g., shipping countries, shipping prices, conversion deals, special services, etc.); and vii) reward program dedicated payment algorithm(s). As illustrated in FIG. 2 and FIG. 3, the universal currency software module running on POGA server 180 may comprise a separate application that may run on a dedicated server. The universal currency software module may also run, for example, on any server shown in FIG. 2 and FIG. 3 or on user interface 190. Moreover, instead of developing a separate database for the universal currency software module, real-time data transfer may be received from reward program server 150, and reward payment server 140. Such data transfers may be established, for example, using Internet data exchange technologies such as XML or equivalent technologies. The aforementioned exchange technologies are exemplary, and others may be used.

POGA database 182 may include data sets that are pertinent to the universal currency software module generating optimal payment pairs. The data sets in POGA database 182 may comprise a combination of imported data from other servers shown in FIG. 2 and FIG. 3 and data generated and/or enriched through the universal currency software module. The files shown in POGA database 182 in FIG. 3 are illustrative and other files may be used.

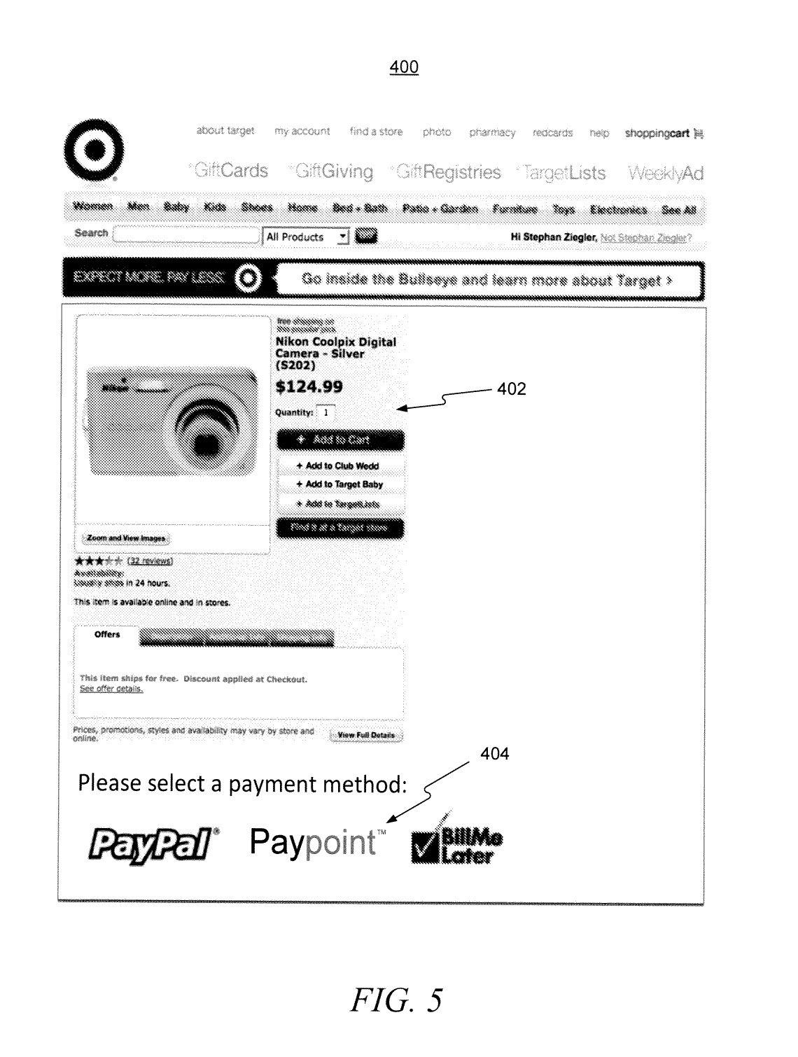

The design and appearance alternatives for user interface 190 may be developed according to, for example, standards and needs of the consumer. The design and appearance of one embodiment is illustrated in FIGS. 5 through FIGS. 13.

Any of the servers in FIG. 2 and FIG. 3, including POGA server 180, (“the servers”) included in system 100 may be implemented using a personal computer, network computer, mainframe, or other similar microcomputer-based workstation. The servers may comprise any type of computer operating environment, such as hand-held devices, multiprocessor systems, microprocessor-based or programmable sender electronic devices, minicomputers, mainframe computers, and the like. The servers may also be practiced in distributed computing environments where tasks are performed by remote processing devices. Furthermore, any of the servers may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the servers may comprise other systems or devices.

Network 195 may comprise, for example, a local area network (LAN) or a wide area network (WAN). Such networking environments are commonplace in offices, enterprise-wide computer networks, intranets, and the Internet. When a LAN is used as network 195, a network interface located at any of the servers may be used to interconnect any of the servers. When network 195 is implemented in a WAN networking environment, such as the Internet, the servers may typically include an internal or external modem (not shown) or other means for establishing communications over the WAN. Further, in utilizing network 195, data sent over network 195 may be encrypted to insure data security by using known encryption/decryption techniques.

In addition to utilizing a wire line communications system as network 195, a wireless communications system, or a combination of wire line and wireless may be utilized as network 195 in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The servers in the wireless environment can be any mobile terminal, such as the mobile terminals described above. Wireless data may include, but is not limited to, paging, text messaging, e-mail, Internet access, and other specialized data applications specifically excluding or including voice transmission.

System 100 may also transmit data by methods and processes other than, or in combination with, network 195. These methods and processes may include, but are not limited to, transferring data via, diskette, CD ROM, facsimile, flash memory sticks, conventional mail, an interactive voice response system (IVR), or via voice over a publicly switched telephone network.

Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general-purpose computer or in any other circuits or systems.

FIG. 4A and FIG. 4B illustrate a flow chart setting forth the general stages involved in an exemplary method 300 consistent with a universal currency software module being accessed, receiving inputs and generating a payment pair in response thereto that may be used to purchase retailer products and services through a retailer's website without having affiliations to non-monetary currencies that may be used to purchase goods and services. Referring, for example, to system 100 of FIG. 2 and FIG. 3, exemplary method 300 describes a shopping process whereby a consumer, accessing a retailer website may purchase items from the retailer website through redeeming non-monetary currency and/or monetary currency, such as cash, in a program that may leverage a dynamic non-monetary currency value generation process. Exemplary ways to implement the stages of method 300 will be described in greater detail below. It should be readily understood that method 300 is merely illustrative and in alternate embodiments of the invention certain steps in method 300 may not be performed or may be performed in a different sequence.

Exemplary method 300 may begin at starting block 302. User 105 may wish to purchase items from a retailer website by accessing a retailer website, reviewing items available for purchase and selecting an item desired to be purchased. Next, the user is presented with a plurality of payment options, including, credit, debit, PayPal® and Paypoint™. Paypoint™ is an option to use non-monetary currency as all or a portion the currency being used in the purchase of an item selected. Upon the user making an interactive selection to use the universal currency system, by selecting the Paypoint™ icon, the user is directed to a universal currency server within the universal currency system, which facilitates user login to a universal currency account. To gain access to the universal currency software module within the POGA server, the user 105 shall enter his/her login and password (stage 304) through user interface 190. The login information may be validated by POGA 180 to ensure, for example, user 105 is a particular universal currency account holder.

Next, POGA server 180 may determine if a user account exists associated with user 105 (stage 306.) For example, if POGA server 180 determines that the user account does not exist, user 105 may access one of reward program servers 150, 112, 114, 116 or 118 (stage 308). In other words, non-reward program members may be referred to, for example, a reward program member sign-up page. For example, user 105 may select a program enrollment option (stage 310) and perform an enrollment process (stage 312.) One of reward program servers 150 may store user data in one of member databases 152 (stage 314.) The reward program servers 150 accessed by user 105 may provide user account details (e.g., login and password) (stage 316).

Next, POGA server 180 may display a personalized welcome page to user 105 on user interface 190 including the non-monetary currency balance for user 105 and some personal details (e.g., name, address, etc) (stage 318). For example, upon login, a personalized welcome page may be displayed including up-to-date non-monetary currency balance for user 105 for a preferred non-monetary currency reward account and may entail other relevant data (e.g., name, address, elite level, etc.). In other embodiments, different types of personal information can be displayed. The personalized welcome page may also contain a selected “dream purchase item” or other personalized features and services based on user 105's preferences and/or past selection of items desired to be purchased. The dream purchase item may be programmed to reference a non-monetary currency accumulated value for a specific reward program or a plurality of reward programs if non-monetary currency from multiple programs may be used as currency to purchase a single item.

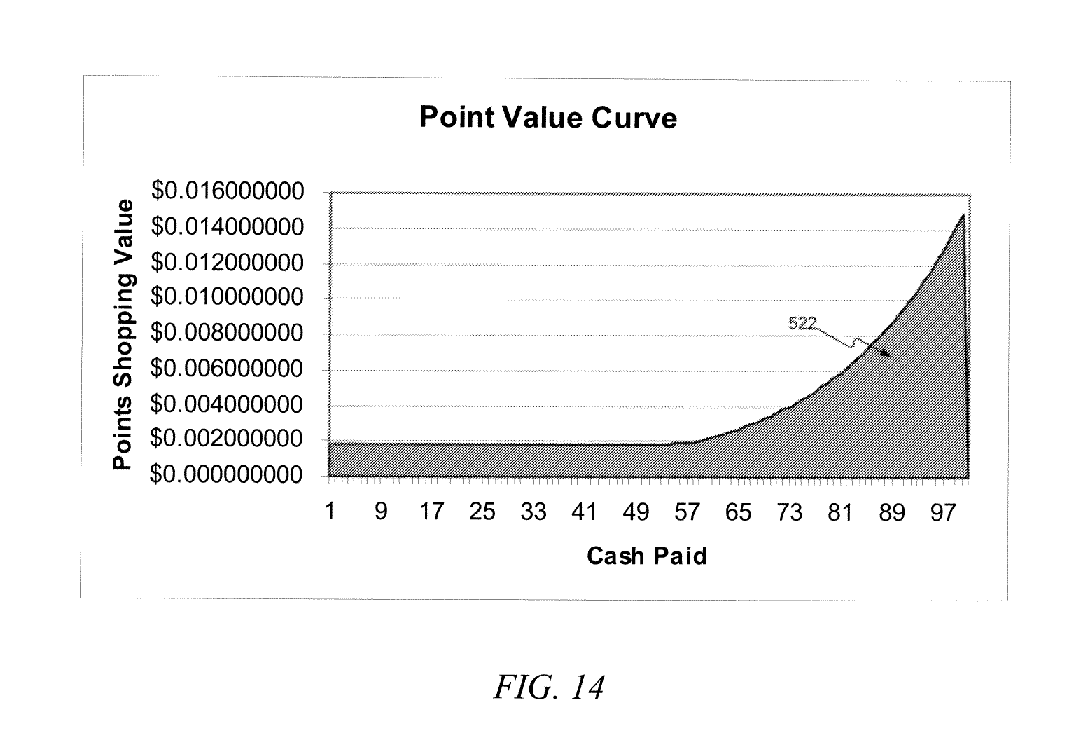

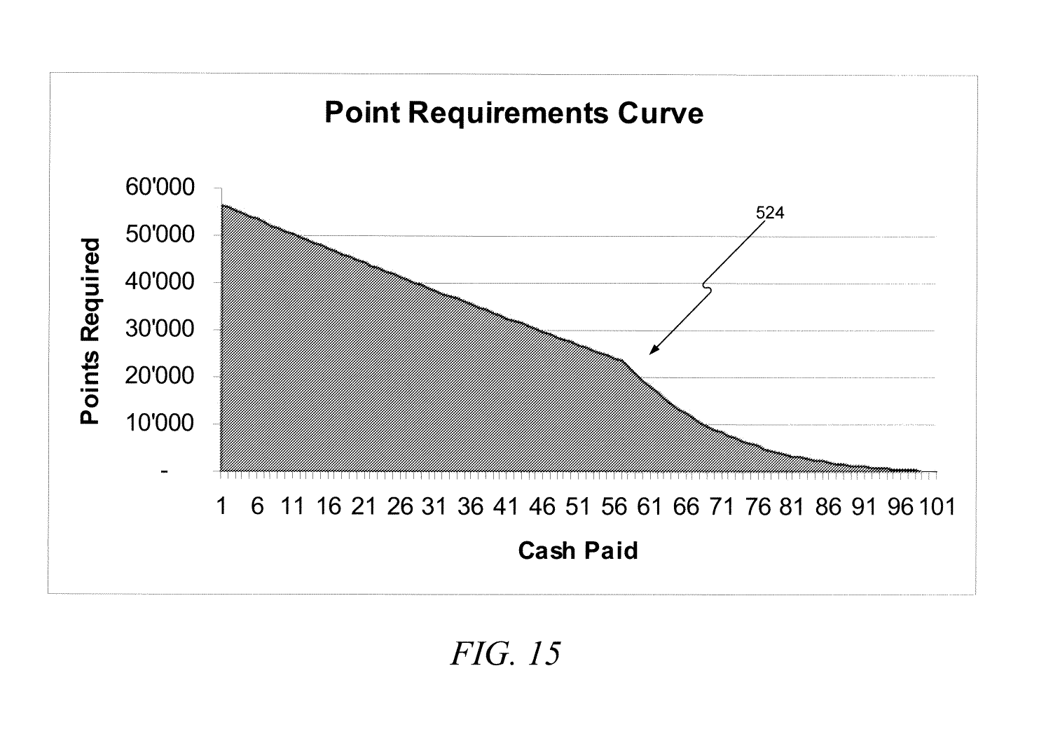

After the welcome page is displayed, user 105 may browse through a plurality of reward accounts, each of which displays a reward account balance and select a preferred reward account (stage 320) from which the non-monetary currency shall be debited upon finalization of an item purchase. Next, POGA server 180 may display to user 105 payment options (non-monetary currency, cash, or any combination thereof) (see Table 2 below) based on the reward program's dynamic currency value algorithm (see Table 1.) POGA server 180 may also display to user 105 reference graphs, such as those described in greater detail below in connection with FIG. 14 and FIG. 15 (stage 322).

Table 1 shows parameters/input values included in an exemplary dynamic non-monetary currency value algorithm (“the algorithm”) used to produce the plurality of payment pairs shown in Table 2 below.

TABLE 1

| | Input Values | | |
|---|---|---|---|
| Algorithm Parameters | | Value | Comment |
| Currency value | c | | |
| Non-currency value | p | | For example: points, |
| | | | miles |
| Retail price | r | 100 | |
| Wholesale price | w | 50 | |
| Any kind of fees | f | 3.00% | Typically below 100% |
| Margins | m | 10.00% | Typically below 100% |
| Coverage price | s | 56.500 | s = w + w*(f + m) |
| Points redemption value | v | 0.001 | |
| Points shopping value growth: | | | |
| Below coverage price | b | 0.10% | Typically below 100% |
| Above coverage price | a | 5.00% | Typically below 100% |

As shown in Table 1, retail and wholesale prices may comprise the retail and wholesales prices of any products or services previously selected by user 105. Fees may be based on the wholesale price, for example. Dynamic fees can be based on the retail price, on the cash payment, or on other factors (e.g., credit card fees, etc.). Furthermore, fees can be flexible and based on service options (e.g., based on shipping options, etc.) or fixed (e.g., internal administration fees, etc.). Depending on the nature of the fees, the algorithm may be different than described in this illustrative example. Margins may comprise desired minimum corporate margins. The non-monetary currency redemption value may comprise the price a reward program is willing to pay for redeeming its non-monetary currency (e.g., points or miles.) Non-monetary currency shopping value growth may define the slope with which the non-monetary currency shopping value for the member grows per additional monetary currency paid. Different growth rates (+ or −) can be applied for any segment on the overall pricing curve.

The following describes the dynamic currency value algorithm, as referred to above, in more detail. As described below, P algorithm may describe a formula for calculating non-monetary currency required based on a selected share of cash a user 105 may intend to pay. C algorithm (derived from P algorithm), may describe a formula for calculating cash required based on the non-monetary currency a user 105 may intend to redeem for a selected reward. The following two algorithms (C and P) are exemplary and can be calculated based on an unlimited number of parameters and an unlimited number of +/− growth rates for each and every parameter. Positive point values are possible, where the user accrues non-monetary currency for a purchase (e.g., when a user pays 100% of the retail price in cash and collects 2 points/$ spent).

If c<=s:

P Algorithm:

$$p = \frac{( r - c ) w ( 1 + f + m )}{{rv ( 1 + b )}^{c}}$$

C Algorithm:

(P Algorithm solved for c):

$$c = \frac{β}{γ} - \frac{Product Log [ \frac{{α}^{\frac{β}{γ}} log ( α )}{γ} ]}{log ( α )}$$

or α_{c}=β−γc where α=(1+b)

$$β = \frac{w ( 1 + f + m )}{vp}$$

$$γ = \frac{w ( 1 + f + m )}{rvp}$$

IF c>s:

P Algorithm:

$$p = \frac{( r - c ) w ( 1 + f + m )}{{rv ( 1 + b )}^{c} {( 1 + a )}^{( c - s )}}$$

C Algorithm:

(P Algorithm solved for c):

$$c = \frac{β}{γ} - \frac{Product Log [ \frac{{α}^{\frac{β}{γ}} log ( α )}{γ} ]}{log ( α )}$$

or αc=β−γc where α=(1+α)(1+b)

$$β = \frac{w ( 1 + f + m ) {( 1 + a )}^{s}}{vp}$$

$$γ = \frac{w ( 1 + f + m ) {( 1 + a )}^{s}}{rvp}$$

Table 2 shows the member payment (i.e., a plurality of payment pairs, each of the plurality of payment pairs comprising a non-monetary currency component and a monetary currency component) as well as the non-monetary currency shopping value, which may comprise the value a member (e.g., user 105) gets for a unit of non-monetary currency (cash paid/non-monetary currency spent.)

TABLE 2

| Cash | Points | Points shopping value | |
|---|---|---|---|
| c | p | (r − c)/p | b or a |
| 0 | 56,500 | 0.00177 | |
| 1 | 55,879 | 0.00177 | 0.001 |
| 2 | 55,259 | 0.00177 | 0.001 |
| 3 | 54,641 | 0.00178 | 0.001 |
| 4 | 54,024 | 0.00178 | 0.001 |
| 5 | 53,407 | 0.00178 | 0.001 |
| 6 | 52,792 | 0.00178 | 0.001 |
| 7 | 52,179 | 0.00178 | 0.001 |
| 8 | 51,566 | 0.00178 | 0.001 |
| 9 | 50,955 | 0.00179 | 0.001 |
| 10 | 50,344 | 0.00179 | 0.001 |
| \| | \| | \| | \| |
| \| | \| | \| | \| |
| \| | \| | \| | \| |
| 90 | 1,042 | 0.00960 | 0.050 |
| 91 | 893 | 0.01008 | 0.050 |
| 92 | 756 | 0.01059 | 0.050 |
| 93 | 630 | 0.01111 | 0.050 |
| 94 | 514 | 0.01167 | 0.050 |
| 95 | 408 | 0.01225 | 0.050 |
| 96 | 311 | 0.01287 | 0.050 |
| 97 | 222 | 0.01351 | 0.050 |
| 98 | 141 | 0.01419 | 0.050 |
| 99 | 67 | 0.01489 | 0.050 |
| 100 | 0 | — | — |

FIG. 14 shows a “non-monetary currency value curve” that may be displayed to user 105 and may indicate the change of the “non-monetary currency shopping value” for user 105. The higher his/her share of cash is in the payment combination, the higher the value of each unit of non-monetary currency may be. As shown in FIG. 14, non-monetary currency value growth, for example, may be 0.1% before achieving the coverage price and may change to 5% after the coverage price for the product is reached. The change in value for user 105 may be important. In the current example, the “non-monetary currency shopping value” starts at $0.00177 (when $1 is paid in cash) and ends at $0.01489 (when $99 is paid in cash) which corresponds to a value increase for the user over 740% (all at the same price per point for the underlying reward program.)

FIG. 15 shows a “non-monetary currency requirements curve” that may indicate the non-monetary currency required to pay for the selected product or service based on the amount of monetary currency (e.g., cash) paid. Again, non-monetary currency required may drop at a higher rate after the coverage price is reached (analogous to explanation for FIG. 14.)

Referring again to FIG. 4A, once POGA server 180 displays payment options (non-monetary currency, monetary currency or any combination thereof), user 105 may lock in a specific payment pair and finalize a payment option by selecting a specific payment pair displayed on the GUI slider payment pair selection module of one embodiment or select a specific payment pair from a plurality of payment pairs displayed on screen in a second embodiment (stage 324). For example, the shopping basket may display a payment pair chosen by user 105. Depending on the application, it may be possible to change the payment pair on one item in a purchase shopping basket or change the payment pair as applied to all items for the entire basket (change the payment pair as applied to all items being purchased within the shopping basket). User 105 may continue shopping for goods and services and/or selects to pay and finalize the transaction (stage 326.)

Next, POGA server 180 may determine if user 105 has enough non-monetary currency (stage 328) to satisfy a minimum non-monetary currency level which may be defined by the user or rules that govern use of non-monetary currency within the reward/loyalty program. For example, before entering the payment page, the POGA server 180 can perform a “non-monetary currency check” with the POGA database 182 or the reward program server 150 to ensure the required non-monetary currency to complete the transaction is available to user 105. A credit card check with credit card server 116 may be performed upon processing the basket payment. If POGA server 180 determines user 105 does not have enough non-monetary currency, user 105 may receive a notification to choose payment according to his/her non-monetary currency balance (stage 330.)

In order to complete the transaction, user 105 may enter the payment pages and confirm selected payment pair(s) as well as shipping preferences (stage 332). Then POGA 180 may execute the cash payment (credit card server 116) and the non-monetary currency payment (stage 334). Next, one of reward program servers 150 may debit non-monetary currency redeemed from user 105's account (stage 336). User may consequently receive the purchased item from the retailer per the estimated delivery date (stage 338). Exemplary method 300 may then end (stage 340).

FIGS. 5 through 13 provide exemplary illustrations of graphical user interfaces that can be displayed on the customer's computing device in accordance with exemplary embodiments of the invention. Referring to FIG. 5, an example of a typical retailer website 400 is shown. The retailer website 400 can be transmitted by the retailer web server 46 to the customer's computing device such as one or more of computing devices 22, 24, 26 or 28. The exemplary retailer website 400 includes information about an item for purchase and its price in field 402. Retailer website 400 also includes different options for the user to pay for the item including the Paypoint™option 404. The Paypoint™ option 404 allows a customer to use loyalty points to pay for a portion or all of an item that is to be purchased.

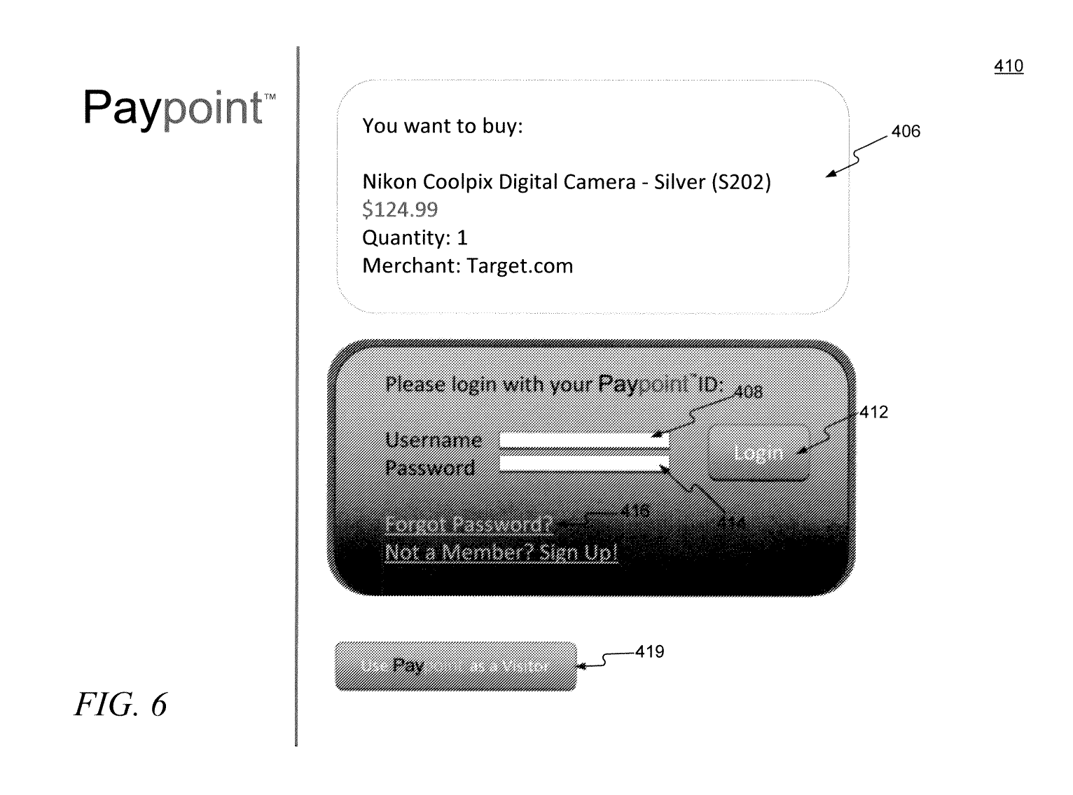

Referring to FIG. 6, an exemplary graphical user interface 410 is shown that can be displayed on a customer's computing device when the customer has selected the Paypoint™ option. User interface 410 includes information about the item to be purchased in field 406. The customer can log in to the universal currency system (also referred to as the Paypoint™ system) by entering their information in fields 408 and 414 and selecting the login button 412. If the customer has forgotten the password, is not yet a member of the universal currency system, or would like to use the system as a visitor, options for these selections are presented at items 416, 418 and 419 in user interface 410.

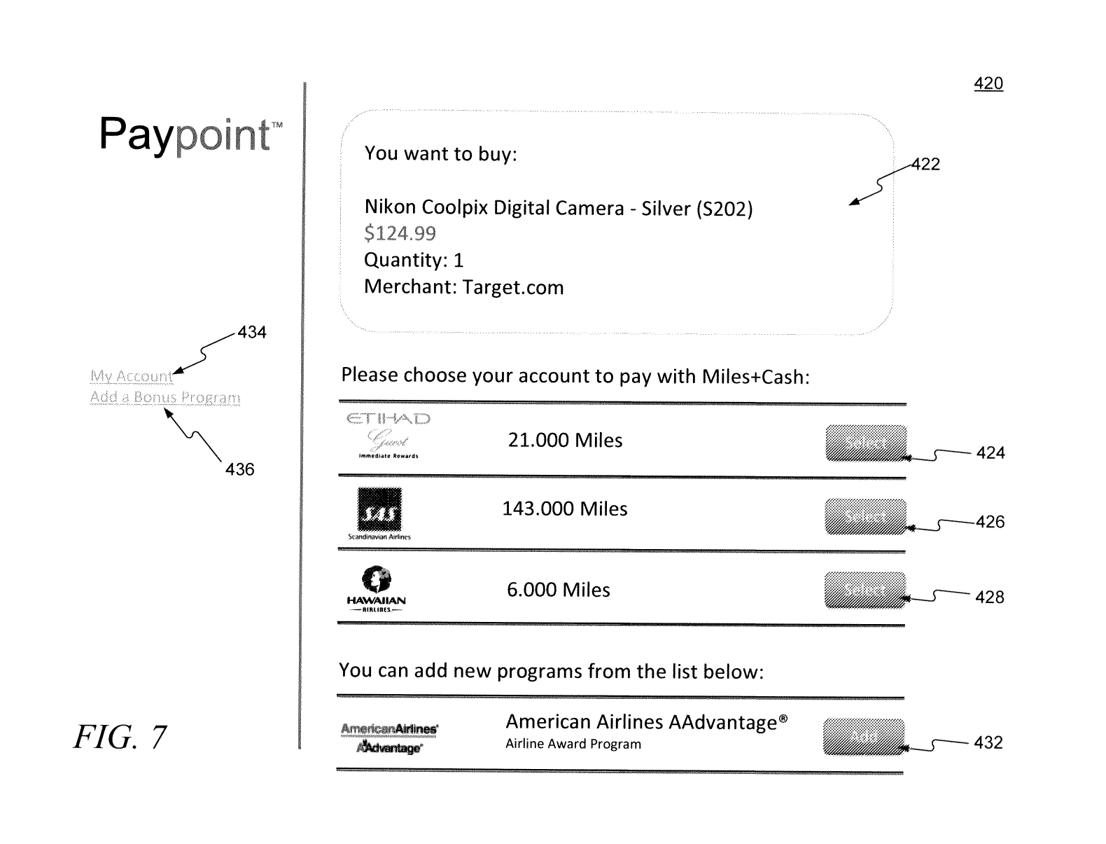

Following entry of the user name and password at user interface 410, the universal currency server 44 displays user interface 420 on the customer's computing device as shown in FIG. 7. User interface 20 includes field 422 containing identifying information for the item to be purchased. In the embodiment illustrated in graphical user interface 420, loyalty/reward programs associated with the customer's universal currency system account are illustrated along with the accumulated reward balances for each respective loyalty program account. In the example illustrated, a customer may select one of three loyalty programs from which to convert non-monetary currency into monetary currency. A first program account, having a reward currency of 21,000 miles may be chosen by selecting button 424. A second program account, having a reward currency of 143,000 miles may be chosen by selecting button 426. A third program account, having a reward currency of 6,000 miles may be chosen by selecting button 428. The graphical user interface 420 also allows a customer to add new reward programs that will then be associated with the customer's universal currency system account by selecting the add button 432.

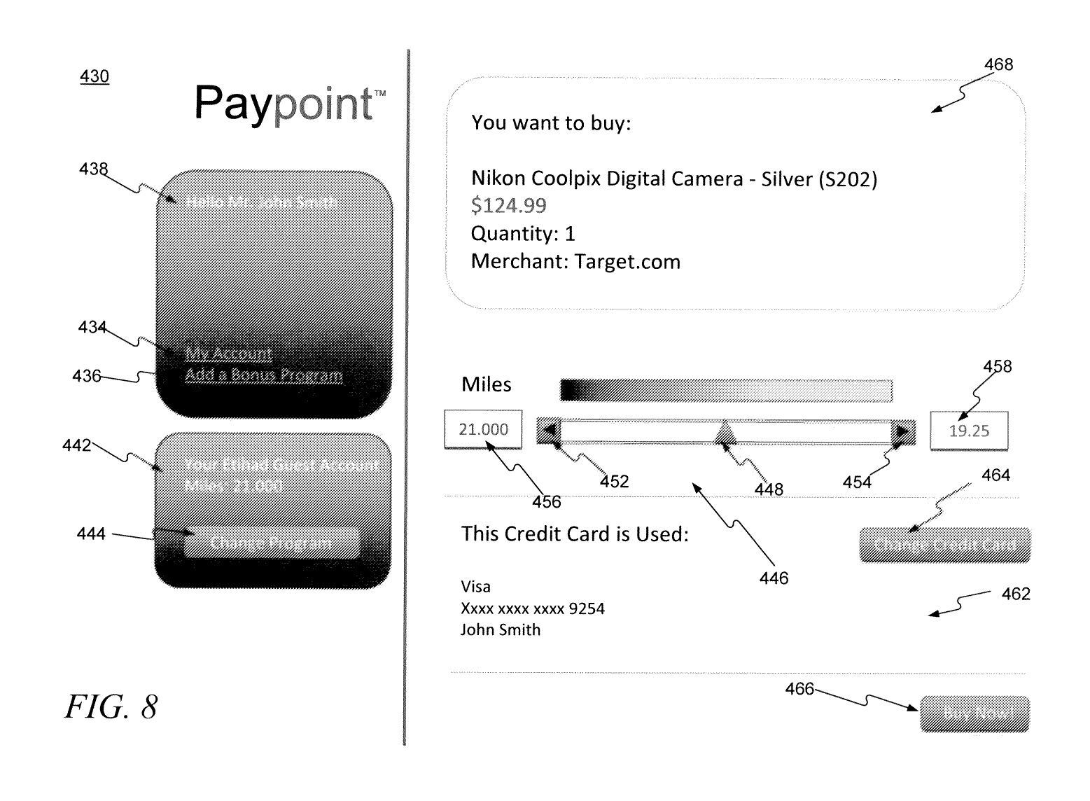

Upon making a selection of a reward account by engaging one of the reward account selection buttons 424, 426, 428, the user is presented with exemplary graphical user interface 430 illustrated in FIG. 8. On the left hand side of user interface 430, the customer's name is shown in field 438 and links to additional information about the customer's account 434, a bonus program 436 and changing to a different program 444 are shown. Also shown is the loyalty account and balance 442 that the customer selected at the previous user interface 420. Field 468 displays the identifying information for the item the customer has selected to purchase. In field 446 of user interface 430, the slider interface is displayed which allows the customer to review and select different payment pairs for purchasing the item. A payment pair comprising a non-monetary component of 21,000 miles 456 and a monetary component of $19.25 is shown in user interface 430. The customer can alter the payment pair by manipulating arrow 448 towards arrow 452 to increase the non-monetary component or towards arrow 454 to increase the monetary component. With respect to the monetary component of the purchase, the customer's default credit card information is displayed in field 462 below the slider interface. If the customer would like to change the default credit card information to another credit card, the customer can select button 464. When the customer has decided on a payment pair and is ready to make the purchase, the customer can select button 466. It should be understood that the payment pair need not always include both a monetary amount and a non-monetary amount. For example, if the customer wants to pay for the purchase using only points, the customer can set the monetary component of the payment pair on the slider interface to zero. Similarly, if the customer decides to pay for the purchase using only monetary currency, the customer can set the non-monetary component of the payment pair on the slider interface to zero. Furthermore, the slider interface shown in field 446 is simply one example of displaying payment pair options to the user. In other embodiments, the user interface can be configured with other graphical components to convey the currency information to the user.

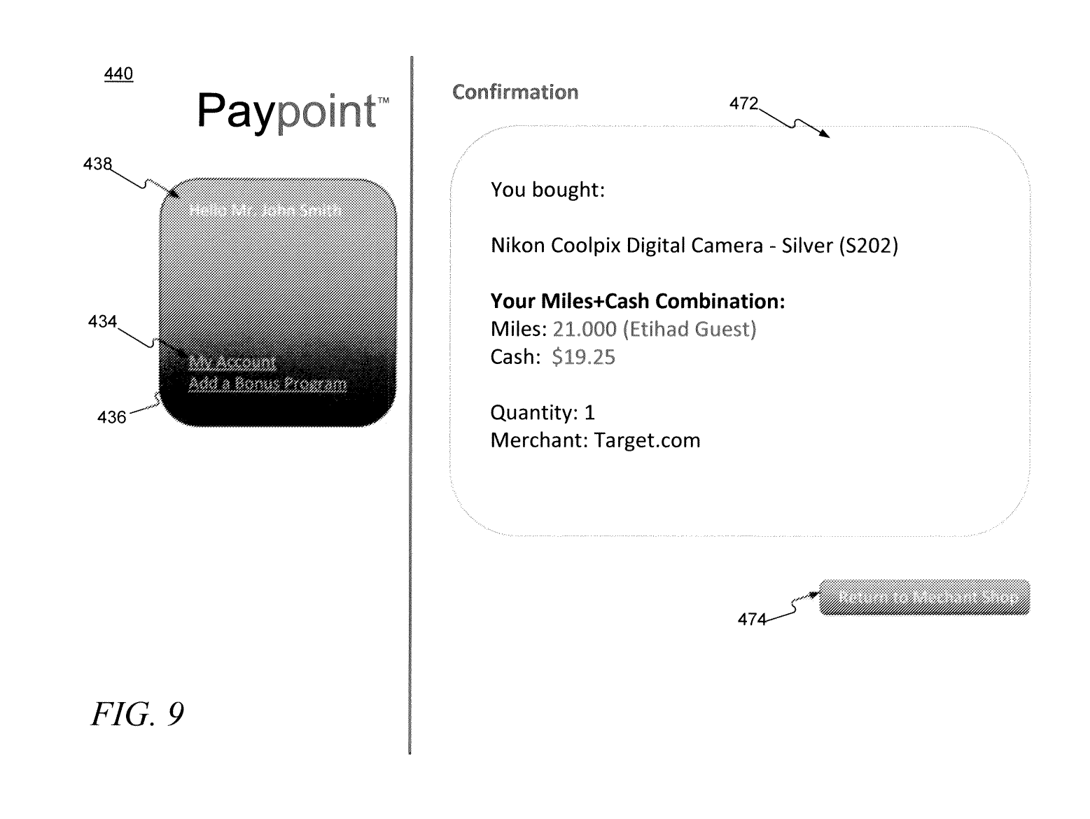

After the customer has purchased the item, the universal currency server 44 transmits a confirmation user interface to the customer's computing device such as user interface 440 shown in FIG. 9. User interface 440 displays field 472 identifying the item purchased and the payment pair amounts. User interface 440 also displays the customer's name 438 and links to the customer's account 434, information about adding a bonus program 436, and the option to return to the retailer's website 474 to continue shopping.

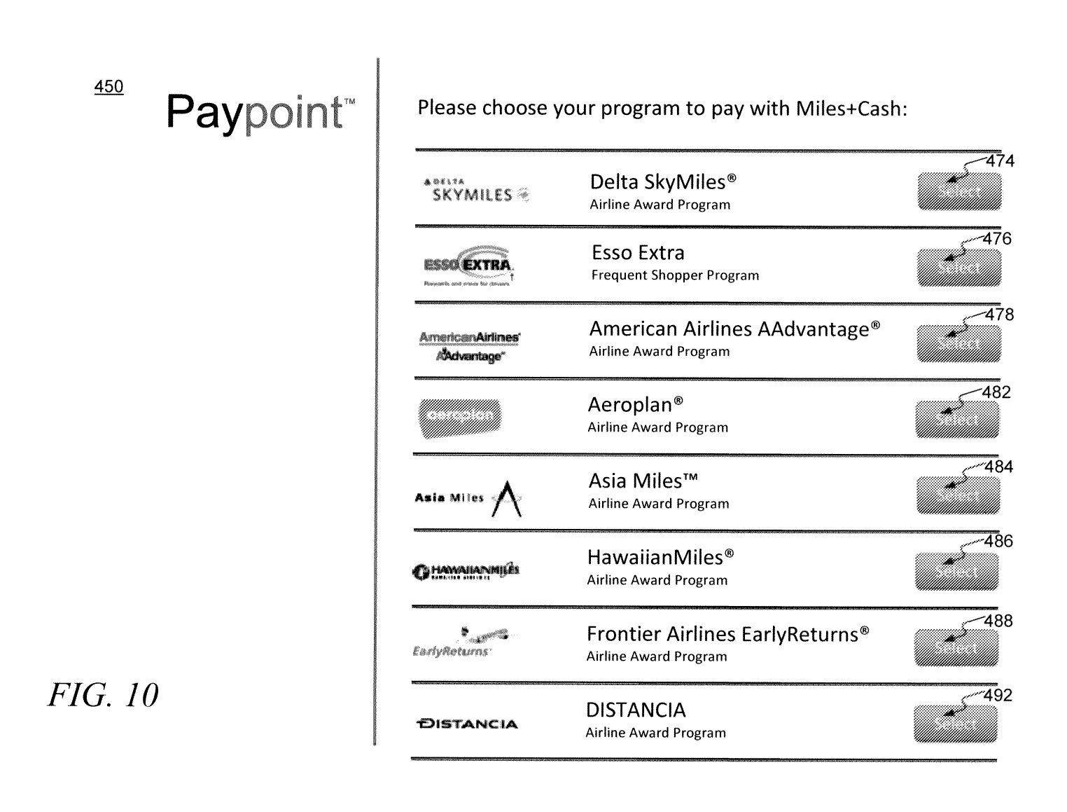

Referring now to FIGS. 10 through 13, an alternate embodiment with alternate user interfaces is illustrated. In FIG. 10, the customer is presented with exemplary graphical user interface 450 wherein loyalty/reward programs associated with the customer's universal currency system account are illustrated. In the example illustrated, a user may select one of eight loyalty programs 474, 476, 478, 482, 484, 486, 488, 492 from which to convert non-monetary currency into monetary currency. In the example illustrated, the user selects a first loyalty program by selecting button 474.

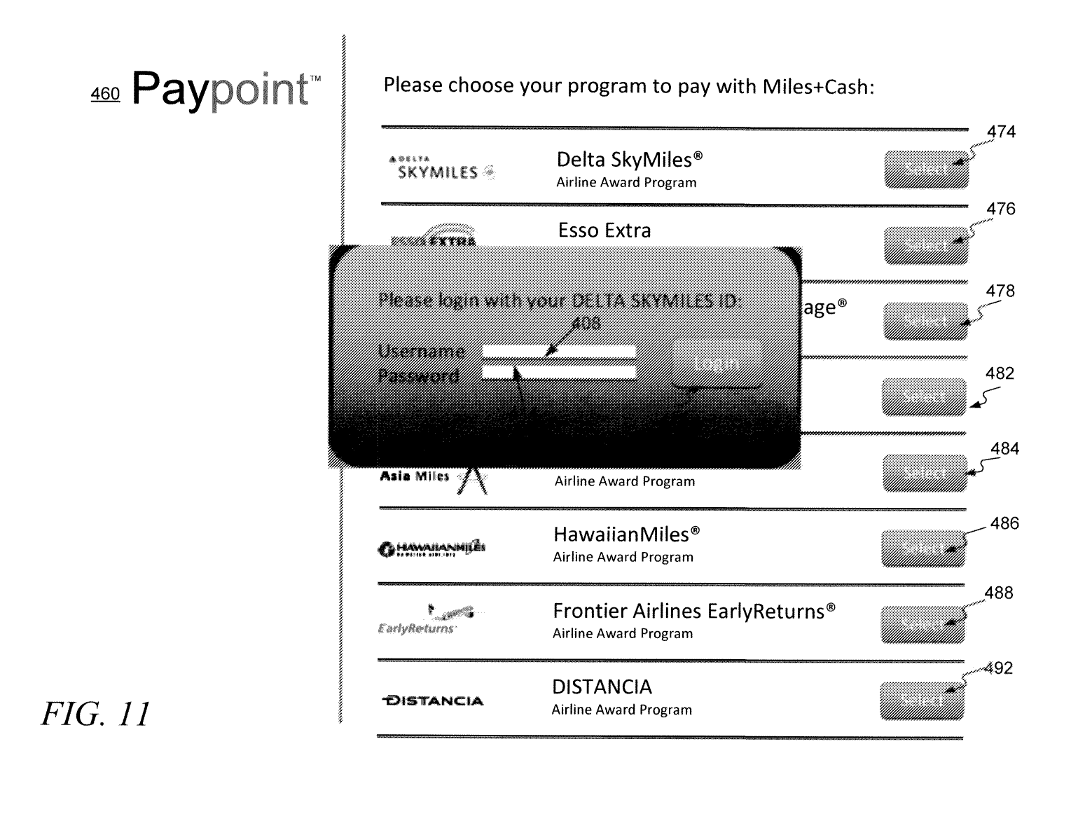

Following selection of a first loyalty program, the user is presented with exemplary graphical user interface 460, as shown in FIG. 11, in which the user is prompted to enter a username 408 and password 414 into respective data fields. Following entry of a username and password into the respective data fields of graphical user interface 460, the customer may initiate processing of the data entered by engaging the login process button 412 which initiates processing of the username and password.

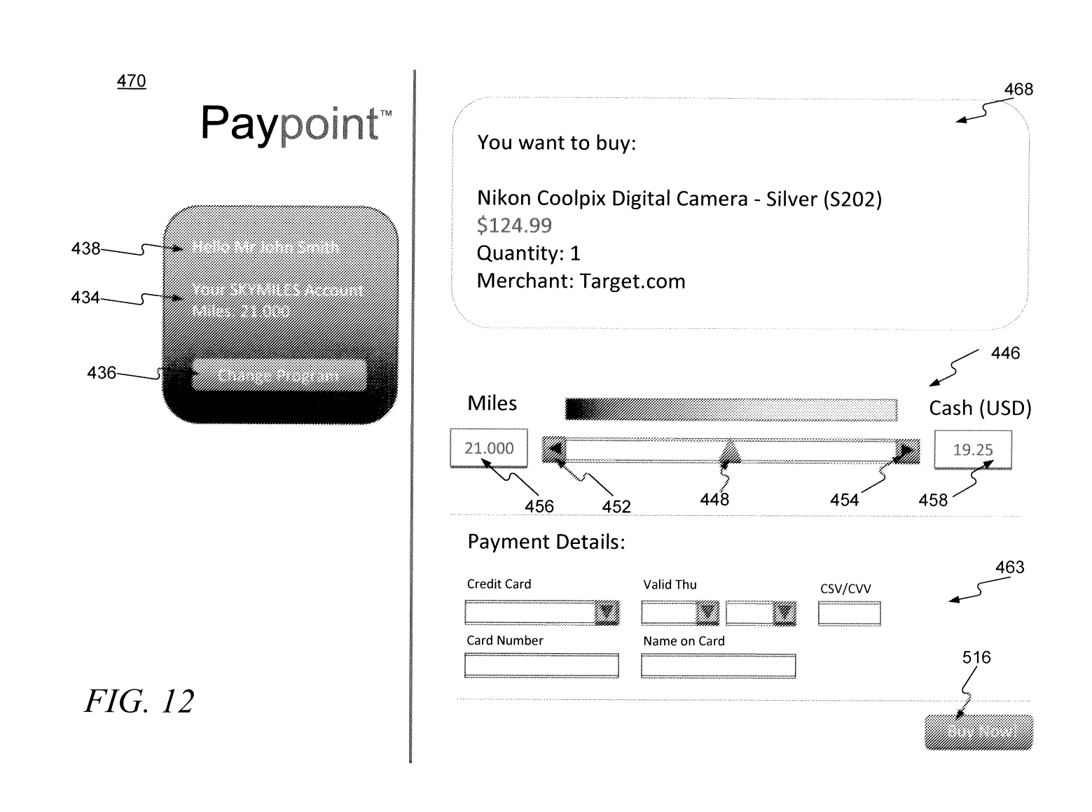

FIG. 12 is similar to FIG. 8 in that user interface 470 displays identifying information for the customer on the left hand side of the user interface and information identifying the product in field 468. The slider interface 446 allows a user to select a payment pair in a similar manner as described in connection with FIG. 8. User interface 470 also includes field 463 allowing a user to enter credit card information for the monetary amount of the payment pair. Once the customer has selected a payment pair and entered the appropriate credit card information, the customer can select button 516 to make the purchase.

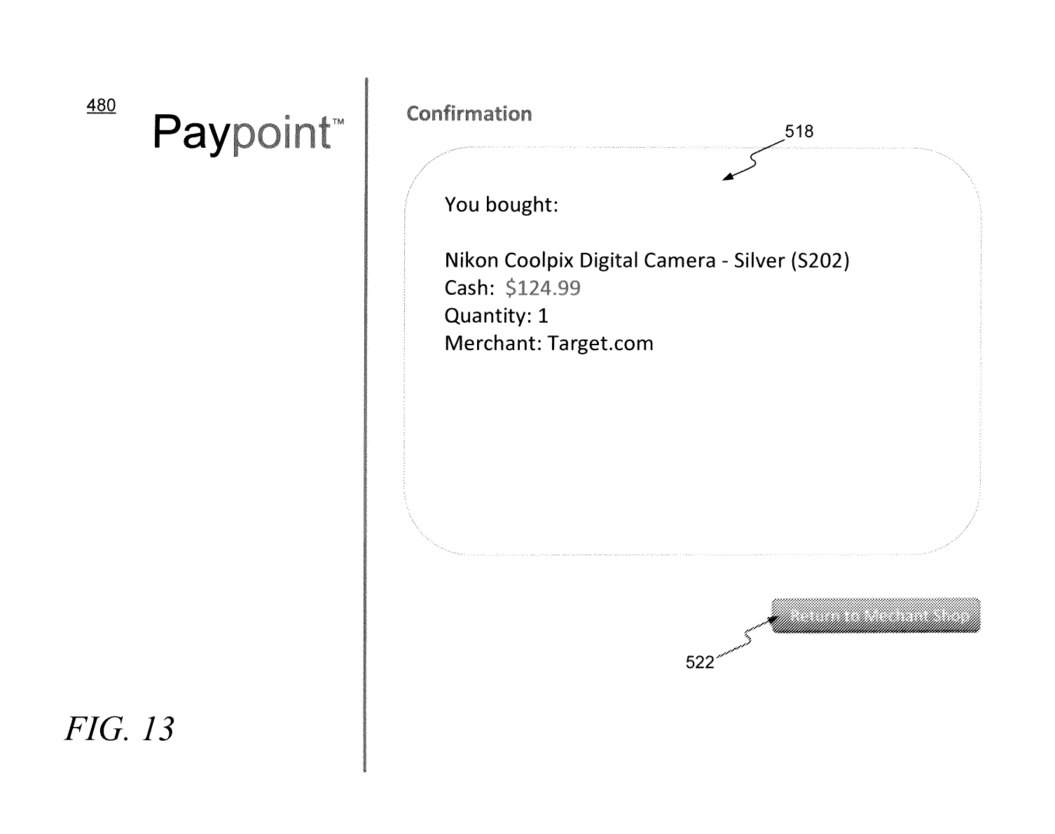

Following the purchase, the universal currency server 44 can transmit a confirmation user interface to the customer's computing device, such as user interface 480 shown in FIG. 13. User interface 480 includes field 518 providing information identifying the item purchased and button 522 which allows the customer to return to the retailer's website.

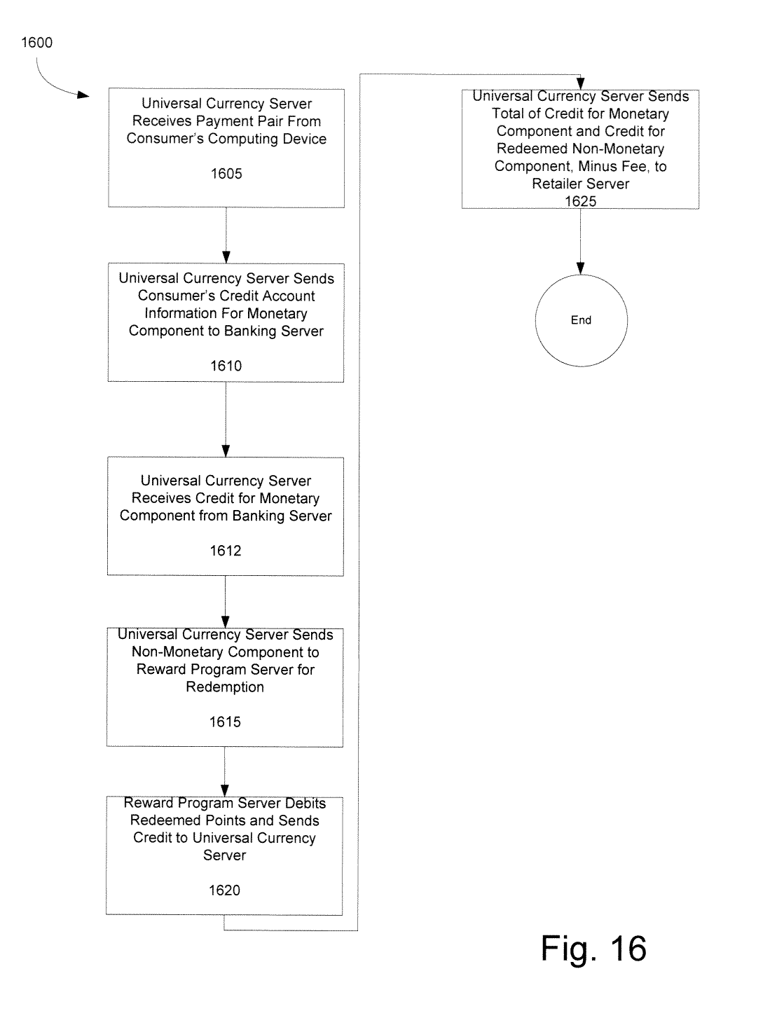

Turning to FIG. 16, a process 1600 is shown explaining in greater detail the movement of loyalty points and monetary currency in accordance with an exemplary embodiment of the invention. Exemplary process 1600 begins at step 1605 with the universal currency server 44 receiving a payment pair from a customer's computing device. Exemplary process 1600 assumes that prior to step 1605, the customer has already selected an item for purchase, logged in with the universal currency system, and manipulated the slider user interface to select a payment pair. These steps preceding step 1605 were described in greater detail in connection with FIGS. 4A and 4B and throughout the foregoing description.

Referring to step 1610, the universal currency server 44 sends a customer's credit card account information for the monetary component of the payment pair to banking server 42. The customer may have a default credit card account associated with the universal currency account. Alternatively, the customer may enter credit card account information when selecting a payment pair. The credit card account information can be associated with banking server 42 or may be associated with a different financial institution that is not affiliated with the universal currency system 10 illustrated in FIG. 1.

In step 1612, the universal currency server 44 receives a credit for the monetary component of the payment pair from the banking server 42. For example, the banking server 42 can charge the credit for the monetary component to the customer's credit card account number which the banking server 42 received from the universal currency server 44.

In step 1615, the universal currency server 44 sends the non-monetary component of the payment pair to the reward program server 48 for redemption. The reward program server 48 will debit an amount of loyalty currency equal to the non-monetary component of the payment pair from the user's loyalty account in step 1620. The loyalty program server 48 also returns a credit for the redeemed loyalty points to the universal currency server 44. The amount of the credit is based on a redemption rate applied to the amount of loyalty currency that was redeemed. As described in connection with the slider interface, the redemption rate can vary depending on a variety of factors including the percentage of the purchase price that is attributed to the non-monetary component or amount. The operator of the universal currency system can invoice the operator of the loyalty program periodically for credits that have been accumulated from redeemed loyalty points.

The universal currency server receives the monetary component credit from the banking server 42 and the credit associated with the non-monetary component from the loyalty program server 48. These combined credits are a payment to the operator of the currency server 44 for the purchased item. In step 1625, the universal currency server 44 sends a payment to the retailer server 46 for the purchased item. This payment to the retailer server 46 for the purchased item is typically equal to the total of the monetary component credit and the credit associated with the non-monetary component, minus a fee charged by the provider of the currency server 44. In alternate embodiments of the invention other fees may be deducted from the credits such as a fee charged by the credit card issuer or a fee charged by the provider of the loyalty program.

Those of ordinary skill in the art will recognize that process 1600 is merely an example and that in other embodiments of the invention process 1600 may be altered to accomplish the same results. For example, certain steps illustrated in process 1600 may occur in parallel or may be altered or combined with other steps in the process.

The dynamic nature of the value of a unit of non-monetary currency generated in the present invention adds additional value to reward programs and the associated non-monetary currency utilized. By making the non-monetary currency for items to be redeemed dynamic, a loyalty/reward program facilitator can make the reward program more attractive by offering additional rewards beyond what is typically offered and what the non-monetary currency generally may be used for. For example, an airline may be able to more effectively offer additional rewards beyond flights that may be purchased with frequent flyer miles. The dynamic nature of the non-monetary currency utilized in the present invention increases the likelihood that airline reward program members will utilize frequent flyer miles currency for items other than flights.

For example, a member may redeem 20,000 miles for a flight having a value of about $400. The cost to the airline for the flight is $50.00. Accordingly, if the airline offers another product or service as a reward to redeem an equivalent number of miles, the airline only has $50.00 to spend. If the airline offers a $50.00 flower arrangement as an alternative to the flight, in most cases, the member of the loyalty program will redeem miles for the flight because the flight has a value of $400.00, in comparison with the $50 retail value for the flower arrangement. Dynamic pricing allows the loyalty program facilitator to increase the value of each unit of the non-monetary currency on a sliding scale up to a point where use of the non-monetary currency has a value close to and in some instances greater than the value of the non-monetary currency when it is used for flights.

In the flower arrangement example, the flower arrangement may actually cost the program facilitator $35.00. If the non-monetary currency holder is willing to spend $35.00 or close to that amount, the program facilitator can afford to give the non-monetary currency holder more value for each unit of non-monetary currency. If the non-monetary currency holder spends $35.00 the program facilitator may ask as little as 500 miles from the user to purchase the flower arrangement, the 500 miles spent on the flower arrangement have a greater value per mile ($0.03), as compared to the value of a mile for an airline flight ($0.02). 20,000 miles for an airline flight that normally costs $400.00 translates that each mile has a value of $0.02. In this situation the member does a calculation on the flower arrangement and determines that paying $35.00 plus 500 miles for a flower arrangement having a $50.00 value means that each mile spent in paying for the flower arrangement has a higher value. This is also viewed in the context of the flower arrangement having been purchased with 20,000 points and $0.00. In this scenario the value of each mile is $0.0025 per mile. Not very many non-monetary currency holders would choose to spend non-monetary currency in this payment pair configuration because the value of each unit of non-monetary currency is too low.

Offering dynamic pay which includes a combination of monetary and non-monetary currency allows a reward/loyalty program to offer varying items other than traditional reward items associated with the program. The solution provided by the present invention helps to generate more value for the holder of the non-monetary currency because if the program member buys the flower bouquet using dynamic non-monetary currency and the dynamic payment method of the present invention, the program member can purchase the flower bouquet partially with monetary currency, thereby causing each unit of the non-monetary currency to increase in value. Accordingly, the counter value of the non-monetary currency maybe more than the value of the frequent flyer miles if they are used towards a flight.

Offering program members the option to purchase goods or services with dynamic non-monetary currency insures that every customer that wants to buy items other than free flights will, somewhere on the pricing scale find a combination of cash and miles which is equivalent to or greater than the value of the miles if the member had redeemed the miles for a free flight.

Another example illustrating the dynamic nature of non-monetary currency generated in the present invention shall be illustrated in the context of airline frequent flyer miles reward program member redeeming non-monetary currency (miles) for a CD player. The CD player has a $100 retail value and a wholesale value of $50. The award program facilitator buys the CD player for $50. The airline frequent flyer program member may purchase the CD player with a payment pair comprised of a monetary currency component of $0.00 and a non-monetary currency component of 20,000 miles. In this example the purchaser is more likely to exchange the 20,000 miles for an airline ticket because the airline ticket has a retail value of $400 in comparison to the CD player, which has a retail value of $100. In this example the counter value of the miles when investing them in a CD player is 25% of an airline ticket. The dynamic non-monetary currency component of the present invention allows the reward program member to purchase the CD player using a combination of non-monetary and monetary currency in which the unit value of each mile shall be equal to or greater than when used to purchase the CD player in comparison to being used for the purchase of an airline flight.

The CD player was purchased for $50. If the reward program member chooses the option to purchase the CD player using a combination of $75 cash and 1,000 miles, the present invention allows the system to provide the purchaser of the CD player with a substantially increased value for each unit of non-monetary currency (miles). Because the reward program member paid $75 cash, the cost of the CD player to the airline has already been covered and also includes a profit margin of $25. The remaining $25 necessary to reach the retail price can be purchased with 1,000 miles, making the counter value of miles in this example greater than the counter value of each mile used in the purchase of an airline ticket. In this example it can be seen that the dynamic non-monetary currency also has the added advantage of providing a reward program in which the reward program sponsor may allow redemption of non-monetary currency for a cost of $0 to the program sponsor or, in other examples the cost is less than the cost associated with the purchase of an airline ticket.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A method for purchasing an item using monetary currency and non-monetary currency comprising:
a universal currency software module receiving a price for the item from a retailer server, the item corresponding to a selection from a customer computer;
the universal currency software module transmitting to the customer computer loyalty account information associated with a customer identifier received from the customer computer;
the universal currency software module receiving from the customer computer a loyalty account selection selected from the loyalty account information;
the universal currency software module transmitting a slider user interface to the customer computer;
the universal currency software module receiving a selected payment pair from the customer computer, the payment pair comprising a monetary currency amount and a non-monetary currency amount;
the universal currency software module transmitting the non-monetary currency amount to a loyalty program server for deletion from the selected loyalty account; and
the universal currency software module receiving a credit associated with the non-monetary currency amount deleted from the selected loyalty account.

2. The method of claim 1, further comprising the step of the universal currency software module receiving a credit for the monetary currency amount from a banking server.

3. The method of claim 3, wherein the credit associated with the non-monetary currency amount and the credit associated with the monetary currency amount are paid to a provider of the universal currency server.

4. The method of claim 1, further comprising the step of the universal currency software module verifying that the non-monetary currency amount is available in the selected loyalty account.

5. The method of claim 1, wherein one of the monetary currency amount and the non-monetary currency amount has a value equal to zero.

6. The method of claim 2, wherein the universal currency software module subtracts a fee from the credit associated with the non-monetary currency amount or the credit associated with the monetary currency amount.

7. The method of claim 6, wherein the universal currency software module transmits a credit to the retailer server equal to the total of the credit associated with the non-monetary currency amount and the credit associated with the monetary currency amount, minus the subtracted fee.

8. A computer-readable storage device comprising computer-readable instructions executed on a computing device, the computer-readable instructions comprising:
first instructions for a universal currency software module to receive a price for an item from a retailer server, the item corresponding to a selection from a customer computer;
second instructions for the universal currency software module to transmit to the customer computer loyalty account information associated with a customer identifier received from the customer computer;
third instructions for the universal currency software module to receive from the customer computer a loyalty account selection selected from the loyalty account information;
fourth instructions for the universal currency software module to transmit a slider user interface to the customer computer;
fifth instructions for the universal currency software module to receive a selected payment pair from the customer computer, the payment pair comprising a monetary currency amount and a non-monetary currency amount;
sixth instructions for the universal currency software module to transmit the non-monetary currency amount to a loyalty program server for deletion from the selected loyalty account; and
seventh instructions for the universal currency software module to receive a credit associated with the non-monetary currency amount deleted from the selected loyalty account.

9. The computer-readable storage device of claim 8, further comprising:
eighth instructions for the universal currency software module to receive a credit for the monetary currency amount from the banking server.

10. The computer-readable storage device of claim 9, further comprising:
ninth instructions for the universal currency software module to pay the credit associated with the non-monetary currency amount and the credit associated with the monetary currency amount to a provider of the universal currency software module.

11. The computer-readable storage device of claim 8, further comprising:
tenth instructions for the universal currency software module to verify that the non-monetary currency amount is available in the selected loyalty account.

12. The computer-readable storage device of claim 8, wherein one of the monetary currency amount and the non-monetary currency amount has a value equal to zero.

13. The computer-readable storage device of claim 9, further comprising:
eleventh instructions for the universal currency software module to subtract a fee from the credit associated with the non-monetary currency amount or the credit associated with the monetary currency amount.

14. A system for purchasing an item using monetary currency and non-monetary currency comprising:
a universal currency server, the universal currency server configured to receive a price for an item from a retailer server, the item corresponding to a selection from a customer computer;
the universal currency server configured to receive from the customer computer a loyalty account selection selected from loyalty account information associated with a customer identifier received from the customer computer;
the universal currency server configured to transmit a slider user interface to the customer computer and to receive a payment pair selected using the slider user interface, the payment pair comprising a monetary currency amount and a non-monetary currency amount;
the universal currency server configured to transmit the non-monetary currency amount to a loyalty program server for deletion from the selected loyalty account; and
the universal currency server configured to receive a credit associated with the non-monetary currency amount deleted from the selected loyalty account.

15. The system of claim 14, wherein the universal currency server is configured to receive a credit for the monetary currency amount from a banking server.

16. The system of claim 15, wherein the credit associated with the non-monetary currency amount and the credit associated with the monetary currency amount are paid to a provider of the universal currency server.

17. The system of claim 14, wherein the universal currency server is configured to verify that the non-monetary currency amount is available in the selected loyalty account.

18. The system of claim 14, wherein one of the monetary currency amount and the non-monetary currency amount has a value equal to zero.

19. The system of claim 15, wherein the universal currency server is configured to subtract a fee from the credit associated with the non-monetary currency amount or the credit associated with the monetary currency amount.

20. The system of claim 19, wherein the universal currency server transmits a credit to the retailer server equal to the total of the credit associated with the non-monetary currency amount and the credit associated with the monetary currency amount, minus the subtracted fee.
